(19) United States
(12) Patent Application Publication
(10) Pub. No.: US 2016/0301641 A1
(43) Pub. Date: Oct. 13, 2016

(54) SECURE MESSAGING SYSTEM UTILIZING A LIMITED VIEWING WINDOW

(71) Applicant: Smoke Messaging, LLC, Los Angeles, CA (US)

(72) Inventor: Wade T. Belliston, Los Angeles, CA (US)

(21) Appl. No.: 15/096,711

(22) Filed: Apr. 12, 2016

Related U.S. Application Data
(60) Provisional application No. 62/146,857, filed on Apr. 13, 2015.

(51) Int. Cl. H04L 12/58; H04W 12/02; H04M 1/725

(52) U.S. Cl. CPC H04L 51/063; H04M 1/72552; H04L 51/046; H04L 51/10; H04L 51/12; H04W 12/02

(57) ABSTRACT

A secure messaging system utilizing a limited viewing window is disclosed. The secure messaging system may prevent an entire message or image from being displayed at a single time. The secure messaging system may display the message on a first virtual layer. The secure messaging system may display a virtual smokescreen layer that conceals the first virtual layer from display. The secure messaging system may enable a visibility window allowing a small portion of the message or image to be displayed through the virtual smokescreen layer. The secure messaging system may delete the message in response to a detected attempted screenshot of the message or image.

### CROSS-REFERENCE TO RELATED APPLICATIONS

This application claims priority to, and the benefit of, U.S. Provisional Application Ser. No. 62/146,857 entitled “SECURE MESSAGING SYSTEM UTILIZING LIMITED VIEWING WINDOW” filed on Apr. 13, 2015, the contents of which are hereby incorporated herein by reference in their entirety.

### TECHNICAL FIELD

The present disclosure relates to electronic messaging, and more specifically to approaches for ensuring message content is viewed only by the intended recipient and not incorporated into a screenshot or other image.

### BACKGROUND

Electronic messaging capabilities have become an essential part of modern life. However, ongoing security concerns regarding electronic messaging remain, such as the ability for a person to take a screenshot on a device, thus transferring the content of an electronic message to a new medium. Some mobile messaging apps use ephemeral, or “disappearing” messages with the intent to make them temporary, but once a screenshot is taken, whatever is on the screen is saved forever. This simple ability to take a screenshot has resulted in many private conversations made public, countless betrayals of trust, embarrassment, and even distribution of illegal images. Accordingly, improved systems and methods for private, secure electronic messaging remain desirable.

### SUMMARY

In various embodiments, a secured messaging system utilizing a limited viewing window is disclosed. The system may comprise a software application operative on a mobile device. The software application may be configured to send and receive messages via a network connection of the mobile device. The software application may be configured to display only a first portion of the contents of a message on a screen of the mobile device. The software application may be configured to conceal the remaining portion of the contents of a message on the screen of the mobile device.

In various embodiments, the first portion may be displayed responsive to a user of the software application maintaining continuous touch on the screen of the mobile device near the location on the screen of the first portion of the contents of the message. The first portion that is displayed may be updated responsive to the user moving their finger to a new location on the screen of the mobile device. In various embodiments, the software application may be configured to rapidly update the location of the first portion on the screen of the mobile device. In various embodiments, the software application may be configured to delete the message in response to a screenshot of the message. In various embodiments, the message may comprise at least one of text, image, or video. In various embodiments, the software application may be configured to conceal the contents of the message through a virtual smokescreen layer displayed on the screen of the mobile device.

In various embodiments, a method of displaying message content on a mobile device screen in a manner resistant to copying via screenshot is disclosed. The method may comprise displaying, on the mobile device screen, only a first portion of the message content in a visibility window. The visibility window may comprise only a portion of the area of the mobile device screen. The method may comprise concealing, on all locations of the mobile device screen outside the visibility window, the message content. The method may comprise moving the visibility window to display a second portion of the message content.

In various embodiments, the first portion may be displayed responsive to a user maintaining a continuous touch on the mobile device screen near the location on the mobile device screen of the first portion of the contents of the message content. The visibility window may be moved in response to the user moving the continuous touch to a new location on the mobile device screen. In various embodiments, the visibility window may be rapidly moved to display the second portion of the message content, such that the entire message content may be discernible by the user. In various embodiments, the method may further comprise deleting the message content in response to a screenshot of the message. In various embodiments, the message content may comprise at least one of text, image, or video. In various embodiments, the method step of concealing the message content may comprise displaying a virtual smokescreen layer on the mobile device screen.

In various embodiments, a computer-based system is disclosed. The computer-based system may comprise a process and a tangible, non-transitory memory configured to communicate with the processor. The tangible, non-transitory memory may have instructions stored thereon that, in response to execution by the processor, cause the processor to perform operations. The operations may comprise displaying, on the mobile device screen, only a first portion of the message content in a visibility window. The visibility window may comprise only a portion of the area of the mobile device screen. The operations may comprise concealing, on all locations of the mobile device screen outside the visibility window, the message content. The operations may comprise moving the visibility window to display a second portion of the message content.

In various embodiments, the first portion may be displayed responsive to a user maintaining a continuous touch on the mobile device screen near the location on the mobile device screen of the first portion of the contents of the message. The visibility window may be moved in response to the user moving the continuous touch to a new location on the mobile device screen. In various embodiments, the visibility window may be rapidly moved to display the second portion of the message, such that the entire message may be discernible by the user. In various embodiments, the operations may further comprise deleting the message in response to a screenshot of the message. In various embodiments, the message may comprise at least one of text, image, or video.

The foregoing features and elements may be combined in various combinations without exclusivity, unless expressly indicated herein otherwise. These features and elements as well as the operation of the disclosed embodiments will become more apparent in light of the following description and accompanying drawings. The contents of this summary section are provided only as a simplified introduction to the disclosure, and are not intended to be used to limit the scope of the appended claims.

### BRIEF DESCRIPTION OF THE DRAWINGS

A more complete understanding of principles of the present disclosure may be derived by referring to the detailed description and claims when considered in connection with the figures, where like reference numbers refer to similar elements throughout the figures, and:

FIG. 1 illustrates an exemplary secure messaging system, in accordance with an exemplary embodiment;

FIG. 2 illustrates a process flow for an exemplary secure messaging system, in accordance with exemplary embodiments;

FIG. 3A illustrates a screenshot of an exemplary secure messaging application operative on a smartphone, in accordance with an exemplary embodiment;

FIG. 3B illustrates a screenshot of an exemplary secure messaging application operative on a smartphone, showing a visibility window when viewing a text message, in accordance with an exemplary embodiment;

FIG. 4A illustrates a screenshot of an exemplary secure messaging application operative on a smartphone, in accordance with an exemplary embodiment; and

FIG. 4B illustrates a screenshot of an exemplary secure messaging application operative on a smartphone, showing visibility window when viewing an image, in accordance with an exemplary embodiment.

### DETAILED DESCRIPTION

The subject matter may be described herein in terms of various functional components and processing steps. It should be appreciated that such components and steps may be realized by any number of hardware, software, or other components configured to perform the specified functions. For example, an exemplary embodiment employs various graphical user interfaces, software components, and database functionality. In addition, various embodiments may be practiced in any number of messaging and/or communications contexts, and the embodiments disclosed are merely indicative of exemplary applications.

For the sake of brevity, conventional techniques for computing, data entry, data storage, networking, software development, encryption, security and access restrictions, and/or the like may not be described in detail herein. Furthermore, the connecting lines shown in various figures contained herein are intended to represent exemplary functional relationships and/or communicative, logical, and/or physical couplings between various elements. It should be noted that many alternative or additional functional relationships or physical connections may be present in a practical secure messaging system.

The software elements of the system may be implemented with any programming or scripting language such as C, C++, C#, Java, JavaScript, Flash, ActionScript, FLEX, VBScript, Macromedia Cold Fusion, COBOL, Microsoft Active Server Pages, assembly, PERL, SAS, PHP, awk, Python, Visual Basic, SQL Stored Procedures, PL/SQL, any UNIX shell script, and/or extensible markup language (XML) or the like, with the various algorithms being implemented with any combination of data structures, objects, processes, routines or other programming elements. Further, it should be noted that the system may employ any number of conventional techniques for data transmission, signaling, data processing, network control, or the like.

Software elements may be loaded onto a general purpose computer, special purpose computer, or other programmable data processing apparatus to produce a machine, such that the instructions that execute on the computer or other programmable data processing means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified herein or in flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of computing hardware and computer instructions. Further, illustrations of the process flows and the descriptions thereof may make reference to user windows, web pages, web sites, web forms, prompts, etc. Practitioners will appreciate that the illustrated steps described herein may comprise any number of configurations including the use of windows, prompts and/or the like. It should be further appreciated that multiple steps as illustrated and described may be combined into single application screens and/or windows but have been expanded for the sake of simplicity. In other cases, steps illustrated and described as single process steps may be separated into multiple application screens and/or windows but have been combined for simplicity.

In various embodiments, components, modules, and/or engines of a secure messaging system may be implemented as micro-applications or “apps”. Apps are typically deployed in the context of a mobile operating system, including for example, a Palm® mobile operating system, a Windows® mobile operating system, an Android® Operating System, Apple® iOS, a Blackberry® operating system, and/or the like. The app may be configured to leverage the resources of the larger operating system and associated hardware via a set of predetermined rules which govern the operations of various operating systems and hardware resources. For example, where an app desires to communicate with a device or network other than the mobile device or mobile operating system, the app may leverage the communication protocol of the operating system and associated device hardware under the predetermined rules of the mobile operating system. Moreover, where the app desires an input from a user, the app may be configured to request a response from the operating system which monitors various hardware components and then communicates a detected input from the hardware to the app.

In various exemplary embodiments, the secure messaging system disclosed herein may enable a more efficient mobile device, while also decreasing the rate of battery usage in the mobile device. Security approaches for messaging systems in the prior art often require additional processing or computation in the mobile device, thus slowing the functioning capabilities of the mobile device and increasing the rate of battery usage in the mobile device. In contrast, the secure messaging system disclosed herein improves the functioning of the mobile device, and the rate of battery usage, by darkening portions of the mobile device screen without requiring increased computation in the mobile device.

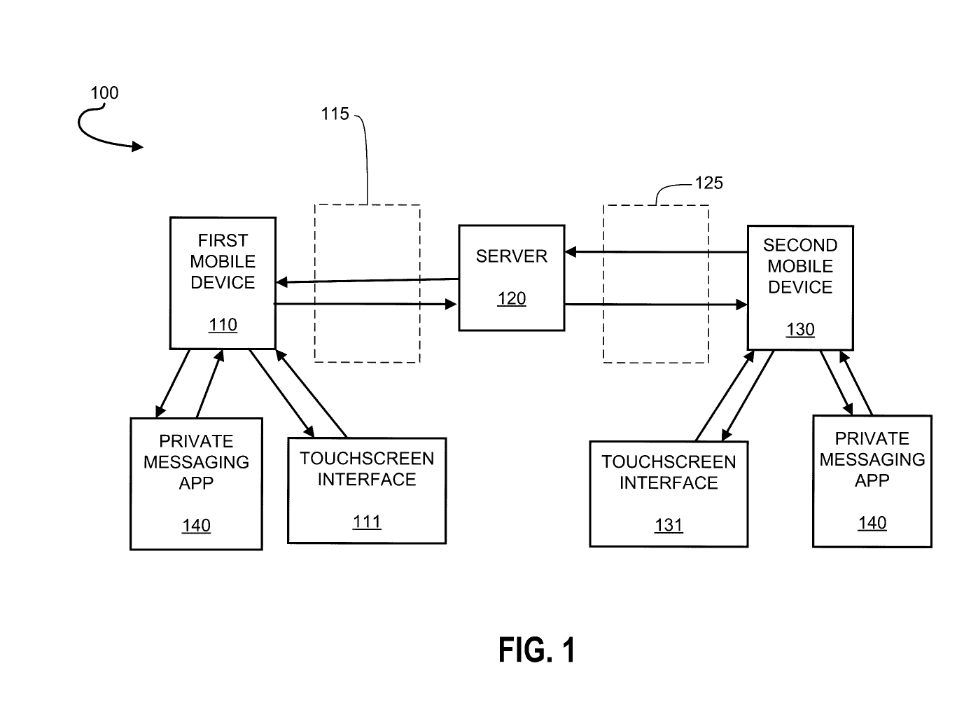

In various exemplary embodiments, and with reference to FIG. 1, a secure messaging system 100 depicted. Secure messaging system 100 may facilitate and secure messaging amongst mobile devices. In this regard, secure messaging system 100 may comprise a first mobile device 110, a server 120, and a second mobile device 130. Any device in secure messaging system 100 may implement suitable security protocols, such as Secure Sockets Layer (SSL) and Transport Layer Security (TLS) for communication over a network. Any device used in secure messaging system 100 may also implement one or more application layer protocols, including, for example, HTTP, HTTPS, FTP, XMPP, and/or SFTP.

In various exemplary embodiments, server 120 may be configured to provide messaging, presence, and routing features. In that regard, server 120 may comprise any suitable type of server, processor, and/or networked device capable of providing messaging, presence, and routing features. For example, server 120 may implement and support various communication standards, such as, for example, XMPP (extensible messaging and presence protocol), SMTP, SMS, MMS, and/or other types of text message technology; email; Facebook®; Twitter®, and/or the like; and/or any other type of communication technology. In various embodiments, network 115, server 120, and/or network 125 may also be a part of and/or comprise a single network capable of providing messaging, presence, and routing features.

In various exemplary embodiments, first mobile device 110 and second mobile device 130 may send and receive messages, and communicate, over network 115 and/or network 125 with server 120. Network 115 and/or network 125 may include a wide area network, such as the Internet, or a local area network. Network 115 and/or network 125 may also include other communication channels such as Bluetooth® or IEEE 802.11 standards, for example. In various embodiments, network 115, network 125, and/or server 120 may comprise and/or be configured with a firewall configured to protect and secure communications in secure messaging system 100. The firewall may include any hardware and/or software suitably configured to protect server 120, first mobile device 110, second mobile device 130, and/or any other components operated by components and/or enterprise computing resources from users of other networks. Further, the firewall may be configured to limit or restrict access to various systems and components behind the firewall for web clients connecting through a web server. The firewall may reside in varying configurations including Stateful Inspection, Proxy based, access control lists, and Packet Filtering among others. The firewall may be integrated within a web server or any other CMS components or may further reside as a separate entity. The firewall may implement network address translation (“NAT”) and/or network address port translation (“NAPT”). The firewall may accommodate various tunneling protocols to facilitate secure communications, such as those used in virtual private networking. The firewall may be integrated as software within an Internet server, any other application server components or may reside within another computing device or may take the form of a standalone hardware component.

In various exemplary embodiments, first mobile device 110 and second mobile device 130 may comprise any electronic device (e.g., personal computer device or mobile communication device) which communicates via any network and/or via a short-range wireless protocol, such as, for example, Bluetooth® or an IEEE 802.11 standard. For example, first mobile device 110 and/or second mobile device 130 may comprise any suitable type of computer-based system disclosed herein or known in the art, such as, for example, a laptop, notebook, server, hand-held computer, personal digital assistant, and/or the like. First mobile device 110 and/or second mobile device 130 may also comprise a networked mobile device such as, for example, a smart phone (e.g., iPhone®, BlackBerry®, Android®, etc.), tablet, wearable computing device such as smart watches, smart glasses, smart rings, and/or any other suitable device capable of sending and receiving data over network 115 and/or network 125.

In various exemplary embodiments, first mobile device 110 may comprise a touchscreen interface 111, configured to receive and capture an input from a user. Touchscreen interface 111 may comprise one or more sensors. The sensors may be configured to capture a user's input when the user makes physical contact, or near physical contact, with touchscreen interface 111. Touchscreen interface 111 may be any suitable size and shape and may be configured in any suitable fashion such that it may receive and capture an input from a user. In various embodiments, touchscreen interface 111 may be disposed and/or included in first mobile device 110. In that regard, touchscreen interface 111 may be any portion of (or an entire screen of) first mobile device 110. Touchscreen interface 111 may also be disposed in any suitable hardware, access point, and/or touch sensitive interface in communication with first mobile device 110. For example, touchscreen interface 111 may be disposed in a door access point, a point of sale device, a mobile phone device, and/or the like.

In various exemplary embodiments, second mobile device 130 may comprise a touchscreen interface 131, configured to receive and capture an input from a user. Touchscreen interface 131 may comprise one or more sensors. The sensors may be configured to capture a user's input when the user makes physical contact, or near physical contact, with touchscreen interface 131. Touchscreen interface 131 may be any suitable size and shape and may be configured in any suitable fashion such that it may receive and capture an input from a user. In various embodiments, touchscreen interface 131 may be disposed and/or included in second mobile device 130. In that regard, touchscreen interface 131 may be any portion or an entire screen of second mobile device 130. Touchscreen interface 131 may also be disposed in any suitable hardware, access point, and/or touch sensitive interface in communication with second mobile device 130. For example, touchscreen interface 131 may be disposed in a door access point, a point of sale device, a mobile phone device, and/or the like.

In various exemplary embodiments, first mobile device 110 and second mobile device 130 may each comprise a private messaging app 140. Private messaging app 140 may reside on first mobile device 110 and/or second mobile device 130. For example, private messaging app 140 may comprise software installed on a mobile device (e.g., first mobile device 110 and/or second mobile device 130), such as a smartphone, a tablet, and/or the like. Private messaging app 140 may also be located on a server, such as in cloud storage, or on server 120, and first mobile device 110 and/or second mobile device 130 may remotely communicate with private messaging app 140.

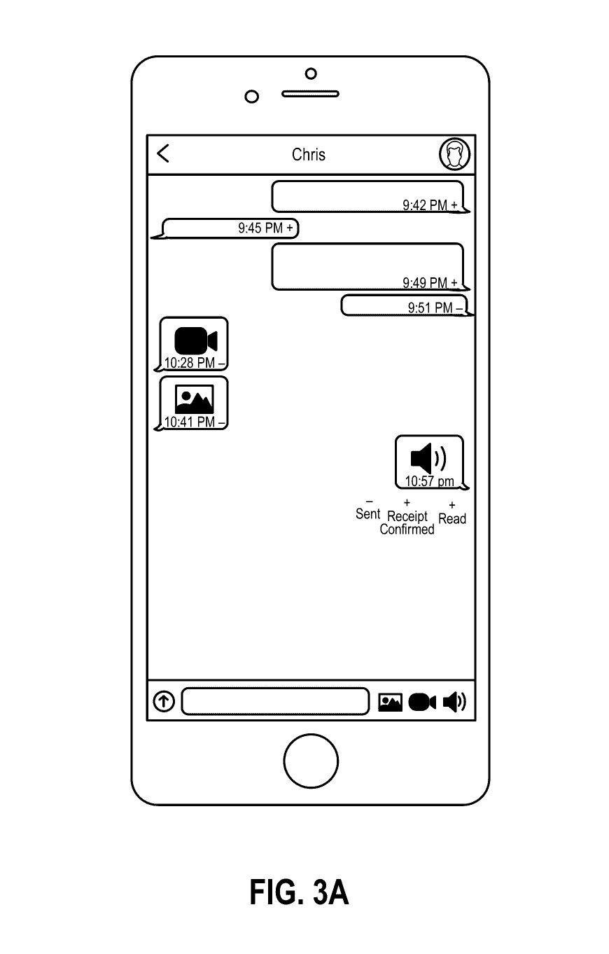

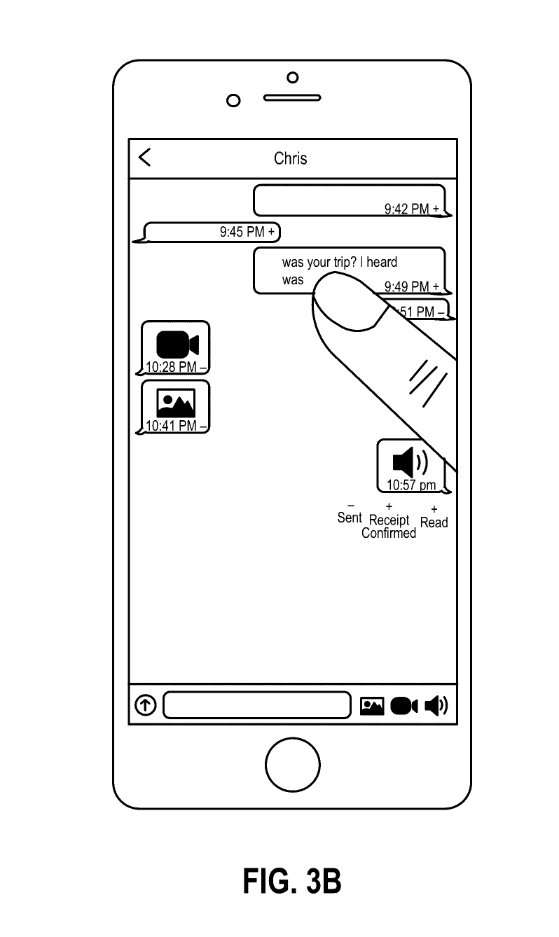

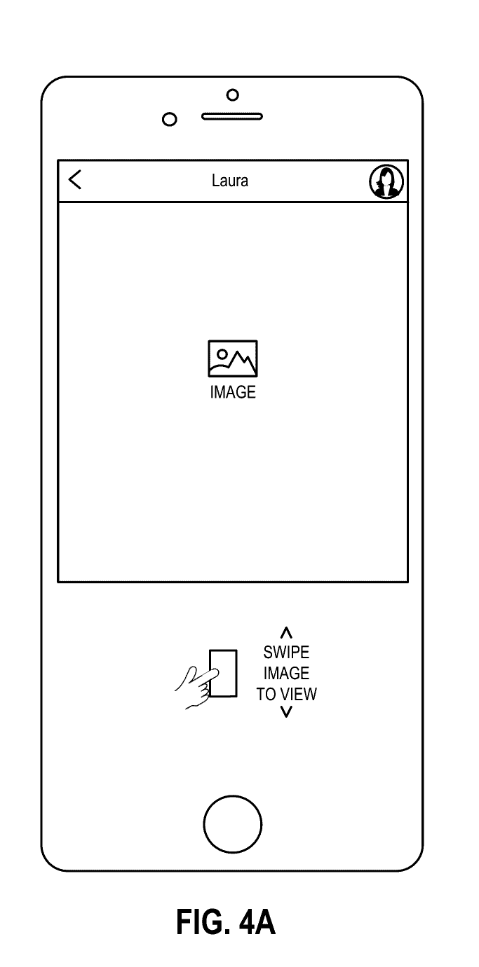

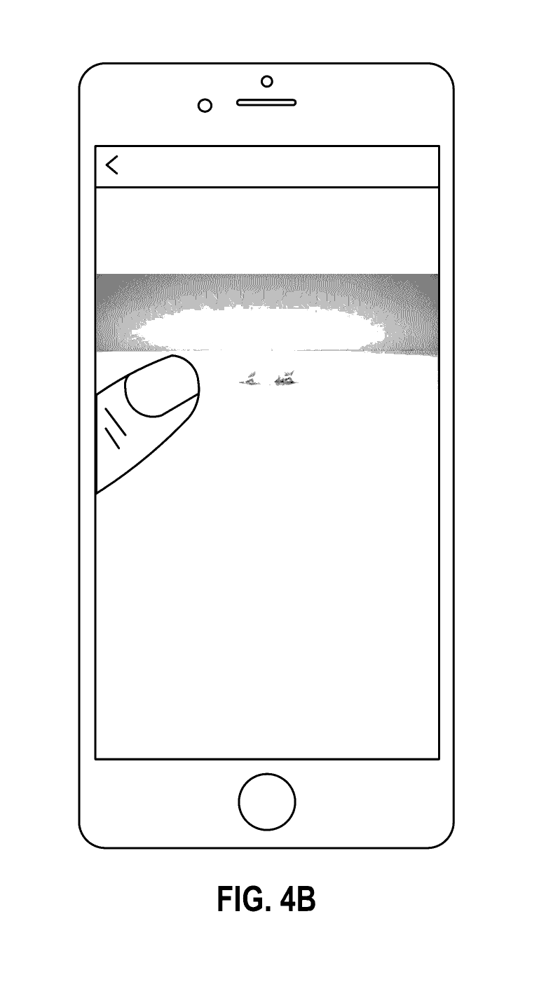

In various exemplary embodiments, private messaging app 140 may be configured to secure messages on first mobile device 110 and/or second mobile device 130. In this regard, private messaging app 140 may be configured to emphasize “front end” security, i.e. to secure messages displayed on touchscreen interface 111 and/or touchscreen interface 131 and to prevent the entire message and/or image from being displayed at once. For sending text, images and videos, private messaging app 140 may function like a typical messaging program, such as the texting program that is standard on a modern smartphone. However, once the messages are sent, for example via network 115 and/or network 125, and the recipient opens them, they are at least partially hidden behind a virtual “smokescreen” layer (e.g., as depicted in FIGS. 3A and 4A). In this regard, the message may be displayed on touchscreen interface 111 (or touchscreen interface 131) as a first virtual layer. The virtual smokescreen layer may be displayed on top of the first virtual layer containing the message, thus hiding the message from view of a user. In various exemplary embodiments, private messaging app 140 is configured with screenshot detection functionality. In this regard, private messaging app 140 may detect user input indicative of a screenshot, via first mobile device 110 and/or second mobile device 130, and remove the message currently displayed. Moreover, private messaging app 140 may send a message to another user, for example the sender of a particular message, responsive to detection of a screenshot.

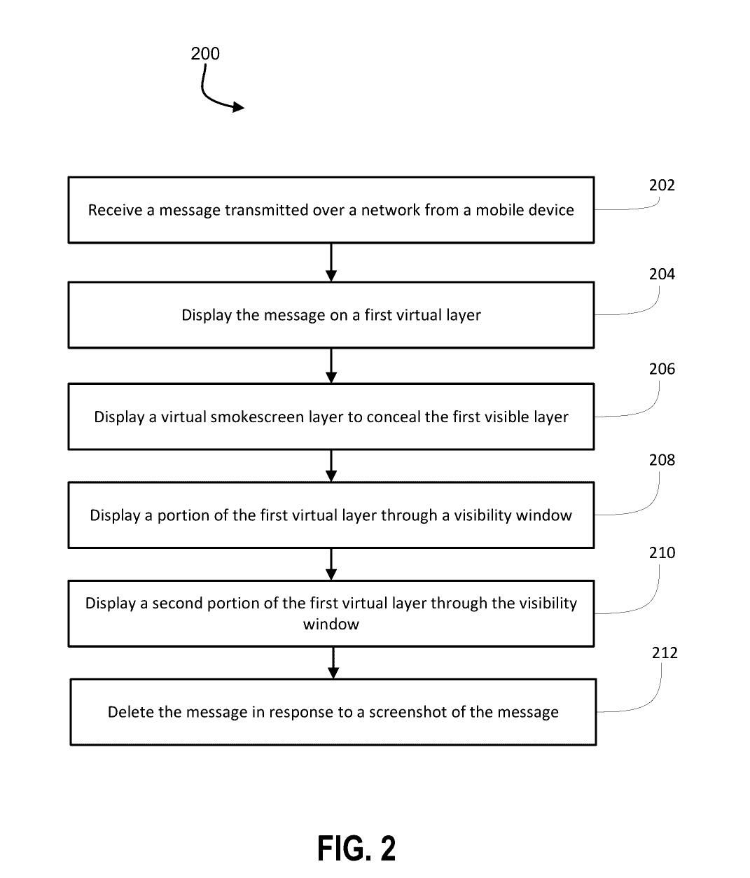

Referring now to FIGS. 2-4B, the process flows and screenshots depicted are merely embodiments and are not intended to limit the scope of the disclosure. For example, the steps recited in any of the method or process descriptions may be executed in any order and are not limited to the order presented. It will be appreciated that the following description makes appropriate references not only to the steps and user interface elements depicted in FIGS. 2-4B, but also to the various system components as described above with reference to FIG. 1.

In various exemplary embodiments, and with reference to FIG. 2, a method 200 for displaying message content on a mobile device screen in a manner resistant to copying via screenshot, is disclosed. Typical secure messaging approaches of the prior art did not offer a moving/moveable window of visibility, and were thus vulnerable to screenshotting and/or to a picture of a mobile device screen being taken by a second mobile device. In contrast, method 200 may enable secure messaging while also preventing screenshotting of the entire message.

In various exemplary embodiments, method 200 may comprise receiving a message transmitted over a network from a mobile device (step 202). In various embodiments, first mobile device 110 may receive a message transmitted over network 115 from server 120. The message may be received by private messaging app 140 on first mobile device 110. The message may be sent from second mobile device 130, via private messaging app 140, to first mobile device 110, via network 125, server 120, and network 115. In various embodiments, second mobile device 130 may receive a message transmitted over network 125 from server 120. The message may be received by private messaging app 140 on second mobile device 130. The message may be sent from first mobile device 110, via private messaging app 140, to second mobile device 130, via network 115, server 120, and network 125. In this regard, server 120 may act as an intermediary to distribute messages to various mobile devices. Server 120 may distribute the messages based on an identifier, such as a user ID, phone number, and/or the like. The message may comprise an image, text-message, video, and/or any other suitable data.

In various exemplary embodiments, method 200 may comprise displaying the message on a first virtual layer (step 204). In various embodiments where first mobile device 110 receives the message, first mobile device 110 may display the message, via private messaging app 140, as a first virtual layer on touchscreen interface 111. In various embodiments where second mobile device 130 receives the message, second mobile device 130 may display the message, via private messaging app 140, as a first virtual layer on touchscreen interface 131. The first virtual layer, in either of the above contexts, may comprise a virtual display of the contents of the message. For example, where the message comprises a text-message, the first virtual layer may comprise the text displayed in a visible format, for example, as text bubbles. Where the message comprises an image, the first virtual layer may comprise the displayed image in a visible format.

In various exemplary embodiments, method 200 may comprise displaying a virtual smokescreen layer to conceal the first visible layer (step 206). In various embodiments where first mobile device 110 (or second mobile device 130) may display the virtual smokescreen layer, via private messaging app 140, to obscure and conceal the first visible layer such that the first visible layer is not visible to a user. With reference to FIGS. 3A and 4A, the virtual smokescreen layer is depicted in greater detail. The virtual smokescreen layer may be configured with any size suitable to conceal the first virtual layer. As illustrated in FIG. 3A, an entire text conversation may be contained within text bubbles on the first virtual layer. The virtual smokescreen layer may be displayed to conceal the text in the text bubbles, such that the text is not visible to the user. As illustrated in FIG. 4A, an image the size of the entire mobile device may be displayed on the first virtual layer. In that regard, the virtual smokescreen layer may comprise a similar size to conceal the first virtual layer from user visibility. In various embodiments, step 206 may be performed in real time or in near real time with step 204, such that a user would not see the first virtual layer display prior to the display of the virtual smokescreen layer (i.e., the virtual smokescreen layer conceals the first visible layer as the first visible layer is displayed). In various exemplary embodiments, the virtual smokescreen layer is displayed as a black color and/or represents a dark, low-, or lowest-energy state of the corresponding pixels in touchscreen interface 111, thus reducing the power draw associated with touchscreen interface 111.

In various exemplary embodiments, method 200 may comprise displaying a portion of the first virtual layer through a visibility window (step 208). In this regard, step 208 may enable the user to view the message (image, text, and/or video) that was concealed in step 206 by the virtual smokescreen layer. The visibility window may comprise a portion of touchscreen interface 111 on first mobile device 110 (or a portion of touchscreen interface 131 on second mobile device 130) that displays the first virtual layer through the virtual smokescreen layer. In that regard, the visibility window may enable the user to securely view a portion of the message at a single time. This effectively allows only a small portion of a text, picture, or video message to be captured by a screenshot, and prevents a screenshot of an entire message. In various embodiments, private messaging app 140 may display the visibility window (on touchscreen interface 111 of first mobile device 110, and/or touchscreen interface 131 of second mobile device 130).

In various embodiments, step 208 may comprise displaying the visibility window in response to a physical contact (or near-contact) by the user. For example, the user may run a finger across touchscreen interface 111 (or touchscreen interface 131). The user may also use a device, such as a stylus, to create the physical contact. Private messaging app 140 may recognize the physical contact, via communication of first mobile device 110 with touchscreen interface 111 (or second mobile device 130 with touchscreen interface 131), and display the visibility window on the portion of touchscreen interface 111 (or touchscreen interface 131) that received the physical contact. In that regard, the physical contact by the user enables a small visibility window from which the user may view a portion of the message on the first virtual layer.

In various exemplary embodiments, method 200 may comprise displaying a second portion of the first virtual layer through the visibility window (step 210). As the user runs a finger across touchscreen interface 111 (or touchscreen interface 131), private messaging app 140 may recognize the location of the physical contact, via communication of first mobile device 110 with touchscreen interface 111 (or second mobile device 130 with touchscreen interface 131), and display the visibility window on the second portion of touchscreen interface 111 (or touchscreen interface 131) that received the physical contact. In that regard, as the user moves the finger around touchscreen interface 111 (or touchscreen interface 131), the visibility window moves with the finger so that the entire message may be viewed, one small visibility window at a time. The user may then slowly control which portion of the message they are viewing.

With reference to FIGS. 3B and 4B, step 208 and step 210 are depicted in further detail. As illustrated in FIG. 3B, physical contact by the user displays the visibility window on the virtual smokescreen layer, enabling the user to view the underlying text message on the first virtual layer. The visibility window creates only a small viewing window through the virtual smokescreen layer, keeping concealed the rest of the text message for added security. In that regard, the visibility window may comprise any size suitable to maintain security of the message. In various embodiments, the user may set the size of visibility window, such as, for example, through a user setting on private messaging app 140. The user may then slide the finger (or lift and tap the finger) to move the visibility window to a second portion of the first virtual layer, such that repeated manual movements of the finger may allow the user to view the entire text conversation. As illustrated in FIG. 4B, physical contact by the user displays the visibility window on the virtual smokescreen layer, enabling the user to view the underlying image on the first virtual layer. The user may then slide the finger (or lift and tap the finger) to move the visibility window to a second portion of the first virtual layer, such that repeated manual movements of the finger may allow the user to view the entire image. In some embodiments, the visibility window may be active only responsive to a user maintaining continuous touch on touchscreen interface 111. In other embodiments, the visibility window may be active at a first location (responsive to a non-continuous touch (e.g., tap) on touchscreen interface 111), and thereafter be relocated to a second location responsive to a tap on touchscreen interface 111. In this manner, the user may either slide a finger around touchscreen interface 111, or repeatedly tap touchscreen interface 111, in order to eventually view all portions of the entire image, message, or the like.

In various embodiments, step 210 may also comprise automatically displaying the second portion of the first virtual layer through the visibility window. In this regard, instead of the user manually moving the physical contact to move the visibility window to display the second portion, private messaging app 140 may be configured to automatically move the visibility window. Private messaging app 140 may move the visiblity window to display the second portion at a fast rate, such that the eye of the user sees the entire message in a short moment. For example, the visible area illustrated in FIG. 4B may move up and down automatically and rapidly enough to give the illusion that the user is looking at the entire picture that fills the screen. However, a screenshot would still only capture a small portion of the message as displayed at the exact moment of the screenshot, just like it would if the visibility window was being moved manually. It will be appreciated that in addition to text or images, the automatically or manually moving visibility window may also be applied over a video, so that a screenshot taken during video playback will only capture a fraction of the image on the screen.

In various exemplary embodiments, method 200 may comprise deleting the message in response to a screenshot of the message (step 212). In this regard, the act of taking a screenshot may automatically trigger a deletion of the message, so that a second screenshot of the message in question may not be taken. Private messaging app 140 may communicate with first mobile device 110 (or second mobile device 130) to recognize an attempted screenshot of the message. Typical mobile devices require a button combination, or other such input, to screenshot the mobile device screen. Private messaging app 140 may therefore monitor first mobile device 110 (or second mobile device 130), and in response to recognizing an input for a screenshot, private messaging app 140 may delete the message.

While the principles of this disclosure have been shown in various embodiments, many modifications of structure, arrangements, proportions, the elements, materials and components, used in practice, which are particularly adapted for a specific environment and operating requirements may be used without departing from the principles and scope of this disclosure. These and other changes or modifications are intended to be included within the scope of the present disclosure and may be expressed in the following claims.

The present disclosure has been described with reference to various embodiments. However, one of ordinary skill in the art appreciates that various modifications and changes can be made without departing from the scope of the present disclosure. Accordingly, the specification is to be regarded in an illustrative rather than a restrictive sense, and all such modifications are intended to be included within the scope of the present disclosure. Likewise, benefits, other advantages, and solutions to problems have been described above with regard to various embodiments. However, benefits, advantages, solutions to problems, and any element(s) that may cause any benefit, advantage, or solution to occur or become more pronounced are not to be construed as a critical, required, or essential feature or element of any or all the claims.

As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

While the steps outlined herein represent exemplary embodiments of principles of the present disclosure, practitioners will appreciate that there are any number of computing algorithms and user interfaces that may be applied to create similar results. The steps are presented for the sake of explanation only and are not intended to limit the scope of the present disclosure in any way. Benefits, other advantages, and solutions to problems have been described herein with regard to specific embodiments. However, the benefits, advantages, solutions to problems, and any element(s) that may cause any benefit, advantage, or solution to occur or become more pronounced are not to be construed as critical, required, or essential features or elements of any or all of the claims.

Systems, methods and computer program products are provided. In the detailed description herein, references to “various embodiments”, “one embodiment”, “an embodiment”, “an exemplary embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. After reading the description, it will be apparent to one skilled in the relevant art(s) how to implement principles of the disclosure in alternative embodiments.

As used herein, big data may refer to partially or fully structured, semi-structured, or unstructured data sets including millions of rows and hundreds of thousands of columns. A big data set may be compiled, for example, from a history of purchase transactions over time, from web registrations, from social media, from internal data, or from other suitable sources. Big data sets may be compiled without descriptive metadata such as column types, counts, percentiles, or other interpretive-aid data points.

Distributed computing cluster may be, for example, a Hadoop® cluster configured to process and store big data sets with some of nodes comprising a distributed storage system and some of nodes comprising a distributed processing system. In that regard, distributed computing cluster may be configured to support a Hadoop® distributed file system (HDFS) as specified by the Apache Software Foundation at http://hadoop.apache.org/docs/.

Any communication, transmission and/or channel discussed herein may include any system or method for delivering content (e.g. data, information, metadata, etc.), and/or the content itself. The content may be presented in any form or medium, and in various embodiments, the content may be delivered electronically and/or capable of being presented electronically. For example, a channel may comprise a website or device (e.g., Facebook, YOUTUBE®, APPLE®TV®, PANDORA®, XBOX®, SONY® PLAYSTATION®), a uniform resource locator (“URL”), a document (e.g., a MICROSOFT® Word® document, a MICROSOFT® Excel® document, an ADOBE® .pdf document, etc.), an “ebook,” an “emagazine,” an application or microapplication (as described herein), an SMS or other type of text message, an email, Facebook®, Twitter®, MMS and/or other type of communication technology. In various embodiments, a channel may be hosted or provided by a data partner. In various embodiments, the distribution channel may comprise at least one of a social media website, an external vendor, a mobile device communication, social media network and/or location based service. Distribution channels may include at least one of a social media site, an external vendor, and a mobile device communication. Examples of social media sites include FACEBOOK®, FOURSQUARE®, TWITTER®, MYSPACE®, LINKEDIN®, and the like. Moreover, examples of mobile device communications include texting, email, and mobile applications for smartphones.

In various embodiments, the methods described herein are implemented using the various particular machines described herein. The methods described herein may be implemented using the herein particular machines, and those hereinafter developed, in any suitable combination, as would be appreciated immediately by one skilled in the art. Further, as is unambiguous from this disclosure, the methods described herein may result in various transformations of certain articles.

The various system components discussed herein may include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases. Various databases used herein may include: client data; merchant data; financial institution data; and/or like data useful in the operation of the system. As those skilled in the art will appreciate, a user computer may include an operating system (e.g., WINDOWS®, OS2, UNIX®, LINUX®, SOLARIS®, MacOS, etc.) as well as various conventional support software and drivers typically associated with computers.

The present system or any part(s) or function(s) thereof may be implemented using hardware, software or a combination thereof and may be implemented in one or more computer systems or other processing systems. However, the manipulations performed by embodiments were often referred to in terms, such as matching or selecting, which are commonly associated with mental operations performed by a human operator. No such capability of a human operator is necessary, or desirable in most cases, in any of the operations described herein. Rather, the operations may be machine operations. Useful machines for performing the various embodiments include general purpose digital computers or similar devices.

In fact, in various embodiments, the embodiments are directed toward one or more computer systems capable of carrying out the functionality described herein. The computer system includes one or more processors, such as processor. The processor is connected to a communication infrastructure (e.g., a communications bus, cross over bar, or network). Various software embodiments are described in terms of this exemplary computer system. After reading this description, it will become apparent to a person skilled in the relevant art(s) how to implement various embodiments using other computer systems and/or architectures. Computer system can include a display interface that forwards graphics, text, and other data from the communication infrastructure (or from a frame buffer not shown) for display on a display unit.

Computer system also includes a main memory, such as for example random access memory (RAM), and may also include a secondary memory. The secondary memory may include, for example, a hard disk drive, flash memory, and/or a removable storage drive, representing a floppy disk drive, a magnetic tape drive, an optical disk drive, a SD card, etc.

In various embodiments, secondary memory may include other similar devices for allowing computer programs or other instructions to be loaded into computer system. Such devices may include, for example, a removable storage unit and an interface. Examples of such may include a program cartridge and cartridge interface (such as that found in video game devices), a removable memory chip (such as an erasable programmable read only memory (EPROM), or programmable read only memory (PROM)) and associated socket, and other removable storage units and interfaces, which allow software and data to be transferred from the removable storage unit to computer system.

Computer system may also include a communications interface. Communications interface allows software and data to be transferred between computer system and external devices. Examples of communications interface may include a modem, a network interface (such as an Ethernet card), a communications port, a Personal Computer Memory Card International Association (PCMCIA) slot and card, etc. Software and data transferred via communications interface are in the form of signals which may be electronic, electromagnetic, optical or other signals capable of being received by communications interface. These signals are provided to communications interface via a communications path (e.g., channel). This channel carries signals and may be implemented using wire, cable, fiber optics, a telephone line, a cellular link, a radio frequency (RF) link, wireless and other communications channels.

The terms “computer program medium” and “computer usable medium” and “computer readable medium” are used to generally refer to media such as removable storage drive and a hard disk installed in hard disk drive. These computer program products provide software to computer system.

Computer programs (also referred to as computer control logic) are stored in main memory and/or secondary memory. Computer programs may also be received via communications interface. Such computer programs, when executed, enable the computer system to perform the features as discussed herein. In particular, the computer programs, when executed, enable the processor to perform the features of various embodiments. Accordingly, such computer programs represent controllers of the computer system.

In various embodiments, software may be stored in a computer program product and loaded into computer system using removable storage drive, hard disk drive or communications interface. The control logic (software), when executed by the processor, causes the processor to perform the functions of various embodiments as described herein. In various embodiments, hardware components such as application specific integrated circuits (ASICs) may be utilized. Implementation of the hardware state machine so as to perform the functions described herein will be apparent to persons skilled in the relevant art(s).

A web client includes any device (e.g., personal computer) which communicates via any network, for example such as those discussed herein. Such browser applications comprise Internet browsing software installed within a computing unit or a system to conduct online transactions and/or communications. These computing units or systems may take the form of a computer or set of computers, although other types of computing units or systems may be used, including laptops, notebooks, tablets, hand held computers, personal digital assistants, set-top boxes, workstations, computer-servers, main frame computers, mini-computers, PC servers, pervasive computers, network sets of computers, personal computers, such as IPADS®, IMACS®, and MACBOOKS®, kiosks, terminals, point of sale (POS) devices and/or terminals, televisions, or any other device capable of receiving data over a network. A web client may run MICROSOFT® INTERNET EXPLORER®, MOZILLA® FIREFOX®, GOOGLE® CHROME®, APPLE® Safari, or any other of the myriad software packages available for browsing the internet.

Practitioners will appreciate that a web client may or may not be in direct contact with an application server. For example, a web client may access the services of an application server through another server and/or hardware component, which may have a direct or indirect connection to an Internet server. For example, a web client may communicate with an application server via a load balancer. In various embodiments, access is through a network or the Internet through a commercially-available web-browser software package.

As those skilled in the art will appreciate, a web client includes an operating system (e.g., WINDOWS® OS, OS2, UNIX® OS, LINUX® OS, SOLARIS®, MacOS, and/or the like) as well as various conventional support software and drivers typically associated with computers. A web client may include any suitable personal computer, network computer, workstation, personal digital assistant, cellular phone, smart phone, minicomputer, mainframe or the like. A web client can be in a home or business environment with access to a network. In various embodiments, access is through a network or the Internet through a commercially available web-browser software package. A web client may implement security protocols such as Secure Sockets Layer (SSL) and Transport Layer Security (TLS). A web client may implement several application layer protocols including HTTP, HTTPS, FTP, and SFTP.

As used herein, the term “network” includes any cloud, cloud computing system or electronic communications system or method which incorporates hardware and/or software components. Communication among the parties may be accomplished through any suitable communication channels, such as, for example, a telephone network, an extranet, an intranet, Internet, point of interaction device (point of sale device, personal digital assistant (e.g., IPHONE®, BLACKBERRY®), cellular phone, kiosk, etc.), online communications, satellite communications, off-line communications, wireless communications, transponder communications, local area network (LAN), wide area network (WAN), virtual private network (VPN), networked or linked devices, keyboard, mouse and/or any suitable communication or data input modality. Moreover, although the system is frequently described herein as being implemented with TCP/IP communications protocols, the system may also be implemented using IPX, APPLE® talk, IP-6, NetBIOS®, OSI, any tunneling protocol (e.g. IPsec, SSH), or any number of existing or future protocols. If the network is in the nature of a public network, such as the Internet, it may be advantageous to presume the network to be insecure and open to eavesdroppers. Specific information related to the protocols, standards, and application software utilized in connection with the Internet is generally known to those skilled in the art and, as such, need not be detailed herein.

The various system components may be independently, separately or collectively suitably coupled to the network via data links which includes, for example, a connection to an Internet Service Provider (ISP) over the local loop as is typically used in connection with standard modem communication, cable modem, Dish Networks®, ISDN, Digital Subscriber Line (DSL), or various wireless communication methods. It is noted that the network may be implemented as other types of networks, such as an interactive television (ITV) network. Moreover, the system contemplates the use, sale or distribution of any goods, services or information over any network having similar functionality described herein.

“Cloud” or “Cloud computing” includes a model for enabling convenient, on-demand network access to a shared pool of configurable computing resources (e.g., networks, servers, storage, applications, and services) that can be rapidly provisioned and released with minimal management effort or service provider interaction. Cloud computing may include location-independent computing, whereby shared servers provide resources, software, and data to computers and other devices on demand. For more information regarding cloud computing, see the NIST's (National Institute of Standards and Technology) definition of cloud computing.

As used herein, “transmit” may include sending electronic data from one system component to another over a network connection. Additionally, as used herein, “data” may include encompassing information such as commands, queries, files, data for storage, and the like in digital or any other form.

The system contemplates uses in association with web services, utility computing, pervasive and individualized computing, security and identity solutions, autonomic computing, cloud computing, commodity computing, mobility and wireless solutions, open source, biometrics, grid computing and/or mesh computing.

Any databases discussed herein may include relational, hierarchical, graphical, or object-oriented structure and/or any other database configurations. The databases may also include a flat file structure wherein data may be stored in a single file in the form of rows and columns, with no structure for indexing and no structural relationships between records. For example, a flat file structure may include a delimited text file, a CSV (comma-separated values) file, and/or any other suitable flat file structure. Common database products that may be used to implement the databases include DB2 by IBM® (Armonk, N.Y.), various database products available from ORACLE® Corporation (Redwood Shores, Calif.), MICROSOFT® Access® or MICROSOFT® SQL Server® by MICROSOFT® Corporation (Redmond, Wash.), My SQL by MySQL AB (Uppsala, Sweden), or any other suitable database product. Moreover, the databases may be organized in any suitable manner, for example, as data tables or lookup tables. Each record may be a single file, a series of files, a linked series of data fields or any other data structure. Association of certain data may be accomplished through any desired data association technique such as those known or practiced in the art. For example, the association may be accomplished either manually or automatically. Automatic association techniques may include, for example, a database search, a database merge, GREP, AGREP, SQL, using a key field in the tables to speed searches, sequential searches through all the tables and files, sorting records in the file according to a known order to simplify lookup, and/or the like. The association step may be accomplished by a database merge function, for example, using a “key field” in pre-selected databases or data sectors. Various database tuning steps are contemplated to optimize database performance. For example, frequently used files such as indexes may be placed on separate file systems to reduce In/Out (“I/O”) bottlenecks.

More particularly, a “key field” partitions the database according to the high-level class of objects defined by the key field. For example, certain types of data may be designated as a key field in a plurality of related data tables and the data tables may be linked on the basis of the type of data in the key field. The data corresponding to the key field in each of the linked data tables is preferably the same or of the same type. However, data tables having similar, though not identical, data in the key fields may also be linked by using AGREP, for example. In accordance with one embodiment, any suitable data storage technique may be utilized to store data without a standard format. Data sets may be stored using any suitable technique, including, for example, storing individual files using an ISO/IEC 7816-4 file structure; implementing a domain whereby a dedicated file is selected that exposes one or more elementary files containing one or more data sets; using data sets stored in individual files using a hierarchical filing system; data sets stored as records in a single file (including compression, SQL accessible, hashed via one or more keys, numeric, alphabetical by first tuple, etc.); Binary Large Object (BLOB); stored as ungrouped data elements encoded using ISO/IEC 7816-6 data elements; stored as ungrouped data elements encoded using ISO/IEC Abstract Syntax Notation (ASN.1) as in ISO/IEC 8824 and 8825; and/or other proprietary techniques that may include fractal compression methods, image compression methods, etc.

In various embodiments, the ability to store a wide variety of information in different formats is facilitated by storing the information as a BLOB. Thus, any binary information can be stored in a storage space associated with a data set. As discussed above, the binary information may be stored on the financial transaction instrument or external to but affiliated with the financial transaction instrument. The BLOB method may store data sets as ungrouped data elements formatted as a block of binary via a fixed memory offset using either fixed storage allocation, circular queue techniques, or best practices with respect to memory management (e.g., paged memory, least recently used, etc.). By using BLOB methods, the ability to store various data sets that have different formats facilitates the storage of data associated with the financial transaction instrument by multiple and unrelated owners of the data sets. For example, a first data set which may be stored may be provided by a first party, a second data set which may be stored may be provided by an unrelated second party, and yet a third data set which may be stored, may be provided by a third party unrelated to the first and second party. Each of these three exemplary data sets may contain different information that is stored using different data storage formats and/or techniques. Further, each data set may contain subsets of data that also may be distinct from other subsets.

The data set annotation may also be used for other types of status information as well as various other purposes. For example, the data set annotation may include security information establishing access levels. The access levels may, for example, be configured to permit only certain individuals, levels of employees, companies, or other entities to access data sets, or to permit access to specific data sets based on the transaction, merchant, issuer, user or the like. Furthermore, the security information may restrict/permit only certain actions such as accessing, modifying, and/or deleting data sets. In one example, the data set annotation indicates that only the data set owner or the user are permitted to delete a data set, various identified users may be permitted to access the data set for reading, and others are altogether excluded from accessing the data set. However, other access restriction parameters may also be used allowing various entities to access a data set with various permission levels as appropriate.

One skilled in the art will also appreciate that, for security reasons, any databases, systems, devices, servers or other components of the system may consist of any combination thereof at a single location or at multiple locations, wherein each database or system includes any of various suitable security features, such as firewalls, access codes, encryption, decryption, compression, decompression, and/or the like.

Encryption may be performed by way of any of the techniques now available in the art or which may become available—e.g., Twofish, RSA, El Gamal, Schorr signature, DSA, PGP, PKI, GPG (GnuPG), and symmetric and asymmetric cryptosystems.

The computing unit of the web client may be further equipped with an Internet browser connected to the Internet or an intranet using standard dial-up, cable, DSL or any other Internet protocol known in the art. Transactions originating at a web client may pass through a firewall in order to prevent unauthorized access from users of other networks. Further, additional firewalls may be deployed between the varying components of CMS to further enhance security.

The computers discussed herein may provide a suitable website or other Internet-based graphical user interface which is accessible by users. In one embodiment, the MICROSOFT® INTERNET INFORMATION SERVICES® (IIS), MICROSOFT® Transaction Server (MTS), and MICROSOFT® SQL Server, are used in conjunction with the MICROSOFT® operating system, MICROSOFT® web server software, a MICROSOFT® SQL Server database system, and a MICROSOFT® Commerce Server. Additionally, components such as Access or MICROSOFT® SQL Server, ORACLE®, Sybase, Informix MySQL, Interbase, etc., may be used to provide an Active Data Object (ADO) compliant database management system. In one embodiment, the Apache web server is used in conjunction with a Linux operating system, a MySQL database, and the Perl, PHP, and/or Python programming languages.

Any of the communications, inputs, storage, databases or displays discussed herein may be facilitated through a website having web pages. The term “web page” as it is used herein is not meant to limit the type of documents and applications that might be used to interact with the user. For example, a typical web site might include, in addition to standard HTML documents, various forms, JAVA® APPLE® ts, JAVASCRIPT, active server pages (ASP), common gateway interface scripts (CGI), extensible markup language (XML), dynamic HTML, cascading style sheets (CSS), AJAX (Asynchronous JAVASCRIPT And XML), helper applications, plug-ins, and the like. A server may include a web service that receives a request from a web server, the request including a URL and an IP address (123.56.789.234). The web server retrieves the appropriate web pages and sends the data or applications for the web pages to the IP address. Web services are applications that are capable of interacting with other applications over a communications means, such as the internet. Web services are typically based on standards or protocols such as XML, SOAP, AJAX, WSDL and UDDI. Web services methods are well known in the art, and are covered in many standard texts. See, e.g., ALEX NGHIEM, IT WEB SERVICES: A ROADMAP FOR THE ENTERPRISE (2003), hereby incorporated by reference.

Middleware may include any hardware and/or software suitably configured to facilitate communications and/or process transactions between disparate computing systems. Middleware components are commercially available and known in the art. Middleware may be implemented through commercially available hardware and/or software, through custom hardware and/or software components, or through a combination thereof. Middleware may reside in a variety of configurations and may exist as a standalone system or may be a software component residing on the Internet server. Middleware may be configured to process transactions between the various components of an application server and any number of internal or external systems for any of the purposes disclosed herein. WEB SPHERE MQ™ (formerly MQSeries) by IBM®, Inc. (Armonk, N.Y.) is an example of a commercially available middleware product. An Enterprise Service Bus (“ESB”) application is another example of middleware.

Practitioners will also appreciate that there are a number of methods for displaying data within a browser-based document. Data may be represented as standard text or within a fixed list, scrollable list, drop-down list, editable text field, fixed text field, pop-up window, and the like. Likewise, there are a number of methods available for modifying data in a web page such as, for example, free text entry using a keyboard, selection of menu items, check boxes, option boxes, and the like.

As will be appreciated by one of ordinary skill in the art, the system may be embodied as a customization of an existing system, an add-on product, a processing apparatus executing upgraded software, a stand-alone system, a distributed system, a method, a data processing system, a device for data processing, and/or a computer program product. Accordingly, any portion of the system or a module may take the form of a processing apparatus executing code, an internet based embodiment, an entirely hardware embodiment, or an embodiment combining aspects of the internet, software and hardware. Furthermore, the system may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

The term “non-transitory” is to be understood to remove only propagating transitory signals per se from the claim scope and does not relinquish rights to all standard computer-readable media that are not only propagating transitory signals per se. Stated another way, the meaning of the term “non-transitory computer-readable medium” and “non-transitory computer-readable storage medium” should be construed to exclude only those types of transitory computer-readable media which were found in In Re Nuijten to fall outside the scope of patentable subject matter under 35 U.S.C. §101.

It should be understood that the detailed description and specific examples, indicating exemplary embodiments, are given for purposes of illustration only and not as limitations. Many changes and modifications may be made without departing from the spirit thereof, and principles of the present disclosure include all such modifications. Corresponding structures, materials, acts, and equivalents of all elements are intended to include any structure, material, or acts for performing the functions in combination with other elements. Reference to an element in the singular is not intended to mean “one and only one” unless explicitly so stated, but rather “one or more.” Moreover, when a phrase similar to “at least one of A, B, or C” or “at least one of A, B, and C” is used in the claims or the specification, the phrase is intended to mean any of the following: (1) at least one of A; (2) at least one of B; (3) at least one of C; (4) at least one of A and at least one of B; (5) at least one of B and at least one of C; (6) at least one of A and at least one of C; or (7) at least one of A, at least one of B, and at least one of C.

What is claimed is:

1. A method for improving the functioning of a mobile device, the method comprising:
receiving, at the mobile device configured with a touch-sensitive display screen, an electronic message comprising at least one of text, image, or video;
displaying, responsive to operation of a mobile application on the mobile device, a first portion of the content of the electronic message within a visibility window on the mobile device display screen;
darkening, responsive to operation of the mobile application on the mobile device, the mobile device display screen outside the visibility window to reduce the amount of electricity drawn from the battery of the mobile device due to operation of the mobile device display screen; and
relocating, responsive to a touch input received at the display screen, the location of the visibility window to conceal the first portion of the electronic message and to display a second portion of the content of the electronic message.

2. A method of displaying message content on a mobile device screen in a manner resistant to copying via screenshot, the method comprising:
receiving, at a first mobile device, a message originating at a second mobile device;
displaying, on a first mobile device screen, only a portion of the message content in a visibility window, the visibility window comprising only a portion of the area of the first mobile device screen;
concealing, on all locations of the mobile device screen outside the visibility window, the message content; and
moving the visibility window to display a second portion of the message content.

3. The method of claim 2, wherein the first portion is displayed responsive to a user maintaining a continuous touch on the mobile device screen near the location on the mobile device screen of the first portion of the contents of the message content.

4. The method of claim 3, wherein the visibility window is moved in response to the user moving the continuous touch to a new location on the mobile device screen.

5. The method of claim 3, wherein the visibility window is rapidly moved to display the second portion of the message content, such that the entire message content may be discernible by the user.

6. The method of claim 2, further comprising deleting the message content in response to a screenshot of the message.

7. The method of claim 2, wherein the message content comprises at least one of text, image, or video.

8. The method of claim 2, wherein concealing the message content comprises displaying a virtual smokescreen layer on the mobile device screen.

9. A secure messaging system, comprising:
a software application operative on a mobile device,
wherein the software application is configured to send and receive messages via a network connection of the mobile device,
wherein the software application is configured to display only a first portion of the contents of a message on a screen of the mobile device, and
wherein the software application is configured to conceal the remaining portion of the contents of a message on the screen of the mobile device.

10. The system of claim 9, wherein the first portion is displayed responsive to a user of the software application touching the screen of the mobile device near the location on the screen of the first portion of the contents of the message.

11. The system of claim 10, wherein the first portion that is displayed is updated responsive to the user touching a new location on the screen of the mobile device.

12. The system of claim 10, wherein the software application is configured to rapidly update the location of the first portion on the screen of the mobile device.

13. The system of claim 9, wherein the software application is configured to delete the message in response to a screenshot of the message.

14. The system of claim 9, wherein the message comprises at least one of text, image, or video.

15. The system of claim 9, wherein the software application is configured to conceal the contents of the message through a virtual smokescreen layer displayed on the screen of the mobile device.
